(19) United States
(12) Patent Application Publication
(10) Pub. No.: US 2026/0325891 A1
(43) Pub. Date: Oct. 22, 2026

(54) SYSTEM FOR EXTINGUISHING KITCHEN FIRE

(71) Applicant: Mirza Faizan, Plano, TX (US)

(72) Inventors: Mirza Faizan, Plano, TX (US); Aamina Mohammad, Plano, TX (US); Vedant Sharma, Plano, TX (US); Adwik Sharma, Plano, TX (US); Abhiram Jetty, Plano, TX (US); Lakshmimanasa Yanamandra, Plano, TX (US); Zahra Fatima Khan, Plano, TX (US); Ayaan Ahmed, Plano, TX (US); Mohammad Masood Siddiqui, Plano, TX (US); Malak Askar, Plano, TX (US); Aimen Khan, Plano, TX (US)

(21) Appl. No.: 19/180,921

(22) Filed: Apr. 16, 2025

(51) Int. Cl. A62C 3/00; A62C 31/02; A62C 37/38

(52) U.S. Cl. CPC A62C 3/006; A62C 31/02; A62C 37/38

(57) ABSTRACT

A fire suppression system for extinguishing kitchen fires comprises a chimney with guide rails and fire-resistant panels, sensors for environmental detection, an actuator for panel movement forming an enclosed tunnel, nozzles connected to a fire suppressant reservoir, an exhaust fan, and a processor with a trained ML model. The processor controls the exhaust fan, actuator, and nozzles based on hazardous condition determinations made from sensor data, ensuring efficient fire suppression. The system's zonal nozzle control, variable-speed fan operation, and user feedback integration enhance precision and adaptability, providing a robust kitchen safety solution.

### TECHNICAL FIELD

This disclosure relates to a fire suppression system and, more specifically, to a system designed to detect and extinguish kitchen fire.

### BACKGROUND

In modern households and commercial kitchens, cooking remains one of the leading causes of indoor fires. These fires often arise from unattended cooking, the ignition of flammable materials, or equipment malfunctions. Despite the availability of traditional fire suppression systems like fire extinguishers, fire blankets, and fixed sprinkler systems, these methods frequently fall short in terms of rapid detection and efficient response tailored to kitchen-specific fire scenarios.

Conventional suppression systems are often manually operated without the intelligence to differentiate between benign and hazardous conditions. This can lead to either false alarms or delayed responses, both of which compromise safety. False alarms may result in unnecessary panic and disruption, while delays in detecting and addressing a fire can lead to extensive property damage, costly repairs, and, in worst-case scenarios, personal injuries or fatalities. The limitations of these systems underscore an urgent need for an advanced apparatus capable of autonomously detecting hazardous fire conditions with high precision and initiating a swift, effective response.

### SUMMARY

The invention offers an efficient and automated solution for extinguishing kitchen fires, ensuring safety and minimizing damage. By incorporating features such as fire-resistant panels, sensors, and a machine learning classification model, the invention accurately detects hazardous fire conditions and responds effectively to suppress the fire. The disclosed fire suppression system is an enclosed tunnel design, coupled with multi-directional nozzles and a high-pressure fire suppressant system, that maximizes fire suppression efficiency while reducing the risk of spreading flames. Additionally, user feedback integration for ML model retraining ensures continuous improvement in accuracy and performance. This invention represents a significant step forward in kitchen safety technology.

The disclosed fire suppression system to extinguish kitchen fire comprises a chimney installed above a stove, the chimney includes a guide rail and a plurality of members configured to slide vertically along the guide rail such that at least one member of the plurality of members is installed along each side of the chimney. The fire suppression system to extinguish kitchen fire further comprises a set of sensors configured to detect environmental conditions in proximity to the stove and an actuator coupled to the plurality of members of the chimney. The apparatus to extinguish kitchen fire further comprises an array of nozzles integrated with the chimney such that the array of nozzles is connected to a high-pressure fire suppressant reservoir and an exhaust fan connected to an end of the chimney. The apparatus to extinguish kitchen fire further comprises a processor that receives information from the sensors related to the environmental conditions detected in proximity to the stove and applies a trained machine learning (ML) model on the received information to determine the detected environmental conditions as a hazardous fire condition in proximity to the stove. The processor upon the determination of the hazardous fire condition in proximity to the stove controls the actuator to slide the plurality of members downward to form an enclosed tunnel around the stove and activates the exhaust fan to extract air from the enclosed tunnel formed around the stove and further activate the array of nozzles to spray fire suppressant within the enclosed tunnel from the high-pressure fire suppressant reservoir.

In an embodiment, the plurality of members comprises fire-resistant panels.

In an embodiment, the plurality of members further includes a sealing mechanism at their base to create an airtight enclosure when the enclosed tunnel is formed around the stove.

In an embodiment, the set of sensors further comprises an infrared camera configured to detect the presence and intensity of heat near the stove and a smoke detector configured to measure smoke concentration in proximity to the stove. The fire suppression system to extinguish kitchen fire further comprises a visible light camera that captures real-time images of the stove for image processing and gas detectors that detects gas leaks by analysing chemical compositions in the environment in the proximity to the stove.

In an embodiment, the information related to the environmental conditions detected in proximity to the stove comprises information detected by the infrared camera, the smoke detector, the visible light camera, and the gas detectors.

In an embodiment, the fire suppressant may include one of carbon dioxide, carbon monoxide, dry chemical powder, water mist, or inert gas.

In an embodiment, the array of nozzles includes multi-directional spray heads and the processor controls the array of nozzles to adjust a direction and flow rate of the fire suppressant based on the information related to the environmental conditions detected in proximity to the stove.

In an embodiment, the array of nozzles is divided into zones, each zone being independently controllable to target specific areas of the enclosed tunnel formed around the stove

In an embodiment, the processor controls the exhaust fan to operate at variable speeds depending on an intensity of the hazardous fire condition.

In an embodiment, the processor sends a notification to a user device prompting confirmation of the determined hazardous fire condition.

In an embodiment, the processor receives feedback to the prompt confirming validity of the determination made by the ML model regarding the hazardous fire condition from the user device and retrain the ML model based on the feedback received from the user device.

In an embodiment, the processor controls the actuator based on the feedback received from the user device.

In an embodiment, the fire suppression system to extinguish kitchen fire comprises an electro-mechanical valve installed on a gas supply line supplying gas to the stove, wherein the processor is further configured to control the electro-mechanical valve to cease gas flow to the stove upon detection of the hazardous fire condition.

In an embodiment, the processor communicates with emergency services when the hazardous fire condition is determined.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a block diagram of a fire suppression system, in accordance with an embodiment of the present disclosure.

FIG. 2 illustrates a perspective view of a fire suppression system in a non-operative mode, in accordance with an embodiment of the present disclosure.

FIG. 3 illustrates a perspective view of a fire suppression system in an operative mode, in accordance with an embodiment of the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

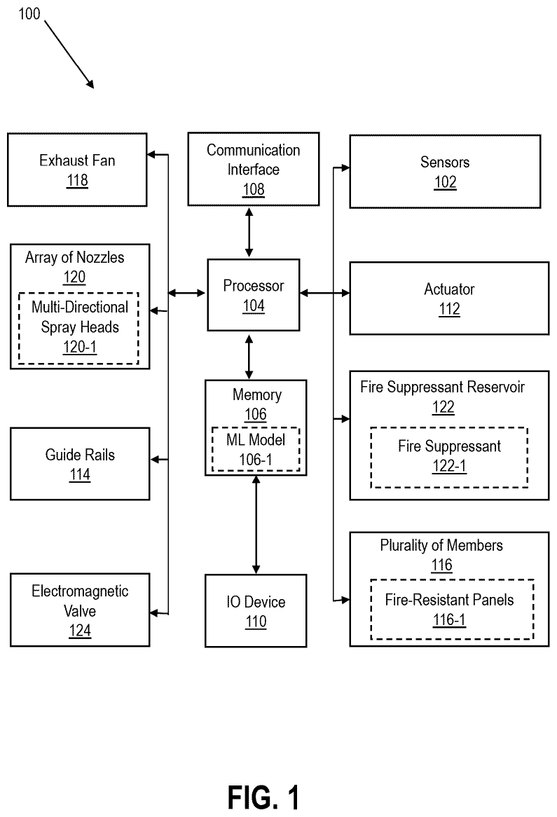

FIG. 1 illustrates a block diagram of a fire suppression system, in accordance with an embodiment of the present disclosure. With reference to FIG. 1, there is shown a fire suppression system 100. The fire suppression system 100 may include sensors 102, a processor 104, a memory 106, a communication interface 108, an Input/Output (IO) device 110, an actuator 112, guide rails 114, a plurality of members 116, an exhaust fan 118, an array of nozzles 120, a fire suppressant reservoir 122, and an electromagnetic valve 124. The memory 106 may store a machine learning (ML) model 106-1. The plurality of members 116 may be fire-resistant panels 116-1. The array of nozzles 120 may include multi-directional spray heads 120-1. The fire suppressant reservoir 122 may include a fire suppressant 122-1.

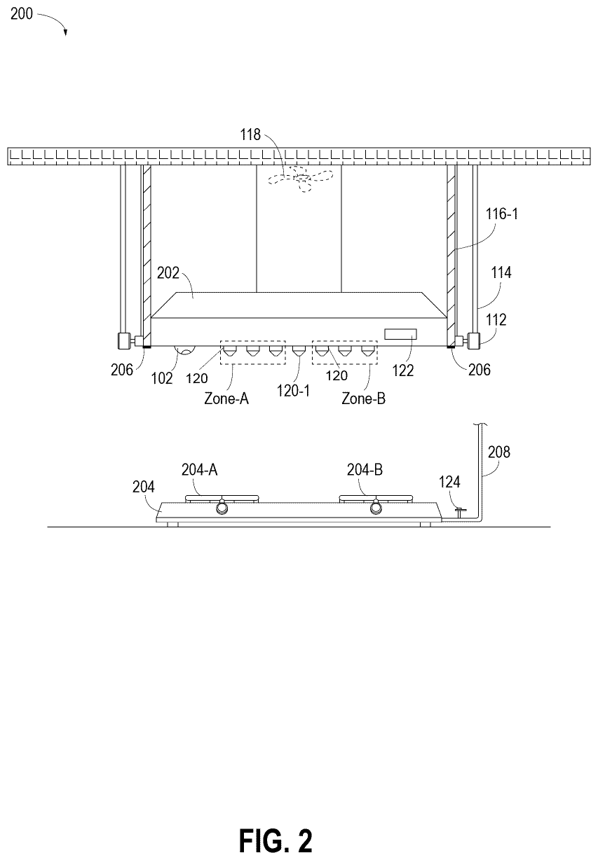

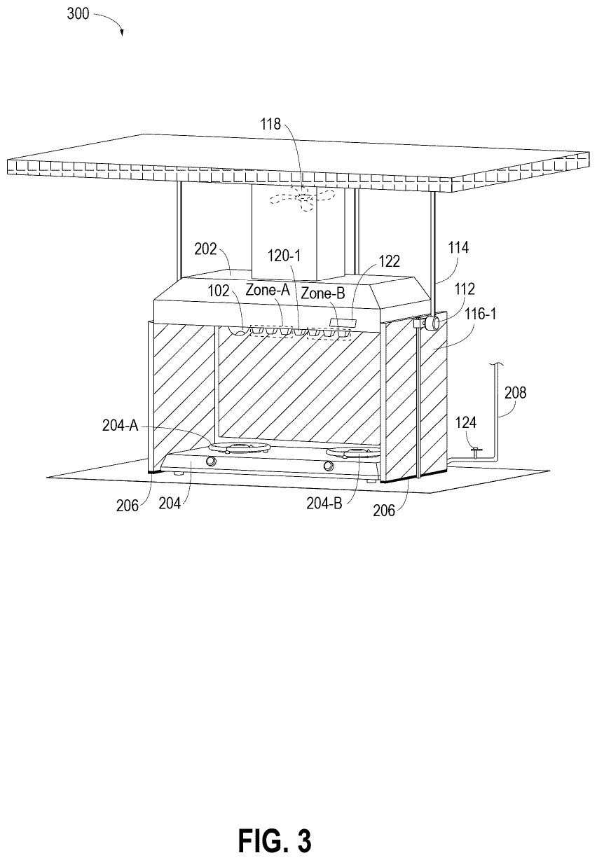

In an embodiment, the sensors 102 detects and monitor environmental conditions in proximity to the kitchen stove (shown in FIG. 2 and FIG. 3 as 204), ensuring accurate identification of hazardous fire situations. These sensors 102 may comprise an infrared camera, a smoke detector, a visible light camera, and a gas detector. Each of these sensors 102 are placed around the stove to monitor various environmental conditions like heat, smoke, and gas leakages. The infrared camera detects heat signatures in the vicinity of the stove. The infrared camera operates by capturing the infrared radiation emitted from objects, which correlates with their temperature. Elevated heat signatures detected by the infrared camera serve as an indicator of a potential fire. The infrared camera continuously monitors the area near the stove, providing real-time data to the processor 104. When temperatures exceed predefined safety thresholds, the processor 104 analyses the data using the trained ML model 106-1 to validate the presence of hazardous fire conditions. This ensures early detection of fire incidents, even before visible flames emerge, enabling rapid intervention to mitigate damage.

The smoke detector identifies combustion by measuring the concentration of smoke particles in the air. The smoke detector is highly sensitive and can distinguish between various smoke densities, allowing it to differentiate minor smoke emissions, such as those from cooking, from significant smoke indicative of a fire. By relaying smoke concentration data to the processor 104, the fire suppression system 100 ensures precise evaluation of fire risk. The trained ML model 106-1 further analyses this data in conjunction with other input of these sensors 102, minimizing false alarms while ensuring reliable fire detection.

The visible light camera is included to capture real-time images of the stove and its surroundings. This visual data provides an additional layer of validation for identifying fire conditions. The visible light camera continuously streams images to the processor 104, which utilizes image processing algorithms to detect visual cues of fire, such as flames, smoke patterns, or discoloration of objects caused by intense heat. These images are crucial for confirming the presence of a fire, especially when other sensors 102 indicate abnormal conditions. Moreover, the visible light camera enhances situational awareness by providing a visual record, which can be used for post-incident analysis or fire suppression system 100 retraining.

Additionally, different image processing algorithms may be used to accurately detect hazardous fire conditions and activate the fire suppression system 100 in real time. Convolutional Neural Networks (CNNs) are highly effective for recognizing fire-related patterns such as flames and smoke by extracting spatial features from images. Complementing this, Optical Flow algorithms may analyse motion in consecutive frames to detect the flickering of flames or billowing smoke. Background Subtraction techniques may highlight sudden changes in the kitchen environment, such as the appearance of fire or smoke. Edge detection methods like the Canny algorithm and image thresholding (e.g., Otsu's method) can further enhance fire identification by isolating bright regions and defining flame contours.

For real-time detection, lightweight algorithms such as Haar Cascade classifiers and YOLO (You Only Look Once) may be used that rapidly identify fire and smoke in kitchen settings. Color-based detection using HSV or LAB color spaces allows the fire suppression system 100 to recognize fire's distinct hues. Semantic segmentation models like U-Net or DeepLab may be used to provide pixel-level classification for precise localization of hazardous areas. Advanced feature matching methods like SIFT and SURF detect fire patterns even under varying conditions, and temporal analysis with RNNs or LSTMs ensures continuous monitoring by identifying time-dependent changes. By integrating these diverse techniques, the fire suppression system 100 can achieve a highly efficient, real-time fire detection mechanism, ensuring a swift and reliable response to prevent kitchen fires.

Gas detectors monitor the chemical composition of the air near the stove, focusing on detecting leaks or hazardous fumes. The gas detectors are calibrated to identify specific gases, such as natural gas or propane, commonly used in stoves. They can also detect by products of incomplete combustion, such as carbon monoxide, which may pose additional risks during a fire. By providing continuous air quality analysis, the gas detectors enable the fire suppression system 100 to address a broader range of hazards beyond fire, such as gas leaks that could lead to explosions if ignited. The processor 104 integrates data from the gas detectors with other inputs of the sensors 102, allowing assessment of potential dangers in the kitchen environment.

The processor 104 receives the data from all these sensors 102 and integrates it to form a comprehensive understanding of the environmental conditions. By applying the trained ML model 106-1, the processor 104 classifies the received data to determine whether a hazardous fire condition exists. For instance, if the infrared camera detects elevated temperatures, the smoke detector identifies high smoke concentrations, and the gas detectors detect combustible gases, the processor confirms a fire hazard based on these combined inputs. Additionally, the visible light camera data serves as a visual validation to ensure the accuracy of the classification.

The collaborative operation of the infrared camera, smoke detector, visible light camera, and gas detectors ensures a robust and multi-faceted approach to fire detection and safety. This integration minimizes false alarms, enhances detection accuracy, and ensures the fire suppression system 100 responds effectively to real threats, protecting both life and property.

In an embodiment, the processor 104 is integrated with computational capabilities to monitor and respond to environmental conditions in proximity to the stove. The processor 104 uses the trained ML model 106-1 which may be a classifier and stored in the memory 106. In an example, the trained ML model 106-1 may be specifically trained on a diverse dataset encompassing various fire-related scenarios, enabling it to classify real-time environmental conditions into predefined categories such as “normal,” “pre-fire,” and “hazardous fire conditions”.

When data is received from the sensors 102, including the infrared camera, smoke detector, visible light camera, and gas detectors, the processor 104 processes this data to detect anomalies or patterns indicative of potential fire hazards. For instance, the trained ML model 106-1 analyses temperature fluctuations detected by the infrared camera, smoke density reported by the smoke detector, and the presence of hazardous gases identified by the gas detectors. By combining these inputs, the processor 104 categorizes the situation.

In an example, however not limited to, the trained ML model 106-1 may be trained to classify environmental conditions into three categories such as normal, pre-fire, and hazardous fire conditions. Under normal conditions, the trained ML model 106-1 identifies standard environmental parameters, such as regular cooking temperatures and the absence of smoke or hazardous gases, determining that no action is required. In contrast, during pre-fire conditions, the processor 104 detects early indicators of a potential fire, such as a sudden rise in temperature or minimal smoke. These early warnings prompt the system to prepare for action, including activating alerts or readying the fire suppression system 100. When conditions exceed safety thresholds, such as the detection of extreme heat, dense smoke, visible flames, or significant gas leaks, the processor 104 classifies the situation as a hazardous fire condition. In such scenarios, the processor 104 initiates immediate responses, including deploying the fire suppression system 100 and notifying emergency services, ensuring a swift and effective reaction to mitigate fire risks.

To further add precision to the fire detection process, the processor 104 may communicate directly with a user device or the IO device 110 to prompt confirmation of a detected hazardous fire condition from the home owner. This functionality ensures user involvement in validating the response of the fire suppression system 100, minimizing false alarms while enhancing the accuracy of hazard management.

The communication interface 108 enables the processor 104 to transmit detailed notifications to the user device or IO device 110, such as a smartphone, tablet, or a dedicated computer using wireless protocols like Wi-Fi, Bluetooth, or cellular networks. The notification generated by the processor 104 includes critical details such as the type of hazard detected (e.g., high temperature, dense smoke, or gas leak), the severity of the condition based on sensor data and ML analysis, and recommended actions for the user. For instance, a push notification might read, “High temperature and smoke detected near the stove. Confirm if this is a fire hazard or a false alarm.” This alert not only informs the user but also includes an interactive prompt to confirm or dismiss the determination by the trained ML model 106-1.

When the notification reaches the user device or IO device 110, the user can respond directly through the interface. The communication interface 108 receives this response and relays it back to the processor 104. Based on the input from the user, the processor 104 decides the next steps. For example, if the user confirms the hazardous condition, the fire suppression system 100 may activate the actuator 112 to deploy the fire-resistant panels 116-1 and form an enclosed tunnel around the stove, trigger the exhaust fan 118, and engage the array of nozzles 120 to release a fire suppressant 122-1 within the enclosed tunnel formed around the stove. Conversely, if the user dismisses the notification as a false alarm, the fire suppression system 100 stands down without initiating fire suppression process.

In one scenario, minor smoke may be detected by the smoke detector due to overcooked food, but the visible light camera does not identify any flames. The trained ML model 106-1 categorizes this as a low-risk event and sends a notification to the user. The user confirms that it is not a fire hazard, allowing the fire suppression system 100 to deactivate without taking further action. In another scenario, the sensors 102 detect a combination of high temperatures, dense smoke, and possibly gas leaks. The trained ML model 106-1 categorizes this as a hazardous fire condition and sends an urgent notification to the user. Upon receiving confirmation, the processor 104 takes immediate action to contain and suppress the fire.

In relation to FIG. 1, the ability of the fire suppression system 100 to analyse sensor data using the trained ML model 106-1 and communicate with the user device or an IO device 110 for notifications and response handlingis illustrated by the interconnected components, the sensors 102 provide critical input to the processor 104 which accesses the trained ML model 106-1 in memory 106 to analyze the situation. The communication interface 108 serves as a bridge between the processor 104 and the user device or IO device 110, ensuring seamless notification and response handling. The fire suppression system 100 enhances safety and reliability by allowing user oversight, preventing false activations while ensuring effective fire suppression

In an additional embodiment, the processor 104 not only receives feedback from the user device or IO device 110 but also uses this feedback to retrain the trained ML model 106-1 stored in the memory 106. This iterative process improves the ability of the fire suppression system 100 to identify hazardous fire conditions with greater accuracy, reducing false alarms and enhancing responsiveness to genuine threats.

However, in another embodiment, the fire suppression system 100 may bypass the user feedback process and directly form the enclosed tunnel based on the real-time analysis performed by the trained ML model 106-1. By continuously monitoring environmental conditions, the trained ML model 106-1 can accurately detect hazardous fire scenarios and autonomously trigger the activation of fire-resistant panels 116-1 without requiring user intervention. This ensures a faster and more reliable response, minimizing delays and enhancing overall safety in critical situations.

Considering an example scenario, when a hazardous condition is detected, the processor 104 analyzes data from the sensors 102, including temperature readings, smoke density, visual imagery, and gas levels and sends a notification to the user device or IO device 110 via the communication interface 108. The user receives a detailed alert describing the detected condition, such as “High temperature and dense smoke detected near the stove. Confirm if this is a fire hazard or a false alarm.” The user then responds, either confirming the hazard as genuine or dismissing it as a false alarm. This feedback is relayed back to the processor 104 for further analysis and action.

The processor 104 may categorize the feedback into two types, confirmations (true positives) and dismissals (false positives). For instance, if the user confirms a detected hazard, the processor 104 records this feedback as validation of the classification done by trained ML model 106-1. On the other hand, if the user dismisses the notification as a false alarm, the processor 104 marks it as a misclassification and prepares the fire suppression system 100 for model retraining.

In an example scenario, to incorporate validation into the fire suppression system 100, the processor 104 may act upon the decision made by the trained ML model 106-1 by initiating the formation of an enclosed tunnel for fire suppression 100. Simultaneously, the fire suppression system 100 prompts the user for confirmation regarding the detected fire hazard. If the user confirms the presence of a fire hazard, the decision by the trained ML model 106-1 may be validated as a true alarm, reinforcing the accuracy of its analysis. However, if the user indicates that no fire hazard exists, the fire suppression system 100 may treat the decision of the trained ML model 106-1 as a false alarm. In such cases, the false positive data is fed back into the trained ML model 106-1 for re-training, improving its future accuracy. Additionally, when a false alarm is detected, the processor 104 may take corrective action by reverting the suppression system 100 to its non-operative state, ensuring minimal disruption while refining the decision-making process of the trained ML model 106-1.

Retraining the trained ML model 106-1 is important and therefore the feedback is combined with the corresponding data by the sensors 102, is compiled into an updated dataset. For example, data related to smoke density, visual imagery, and heat levels during a false alarm are flagged as non-hazardous. Conversely, data from an unrecognized fire hazard are flagged as critical. The updated dataset is then used to retrain the trained ML model 106-1 may be by using supervised learning techniques. Depending on the fire suppression system 100 configuration, this retraining can occur locally on the processor 104 or may be via cloud-based processing using the communication interface 108. Once retrained, the updated trained ML model 106-1 is stored in memory 106, replacing the previous version.

In one scenario, during regular cooking, the smoke detector senses increased smoke levels, but the visible light and infrared cameras do not detect flames or high heat. The trained ML model 106-1 may categorizes this as a hazardous fire condition and notifies the user. Upon receiving the notification, the user dismisses the alert, indicating it was a false positive triggered by cooking smoke. The fire suppression system 100 may record this feedback and retrains the trained ML model 106-1 to deprioritize smoke as a hazard in similar low-temperature contexts. The updated trained ML model 106-1 is stored in memory 106 to prevent future false alarms in such scenarios.

In another instance, the sensors 102 detect moderate heat and smoke, but the trained ML model 106-1 fails to classify the situation as hazardous. The user notices the developing fire and manually intervenes to activate the suppression system 100. The feedback of the user is recorded as a false negative, may be highlighting the inability of trained ML model 106-1 to recognize the fire. The fire suppression system 100 retrains the trained ML model 106-1 to prioritize similar patterns given by the sensors 102, ensuring it identifies such conditions as hazardous in the future. The updated trained ML model 106-1 enhances the ability of the fire suppression system 100 to respond proactively to early signs of fire.

This feedback and retraining process enhances the fire suppression system 100 reliability. By continuously learning from user input, the fire suppression system 100 becomes more adept at distinguishing genuine hazards from false positives, reducing unnecessary activations and instilling greater user confidence.

Additionally, the fire suppression system 100 ability to communicate with emergency services when a hazardous fire condition is detected with proper communication interface 108. This feature ensures timely external intervention in situations where the fire's severity exceeds the fire suppression system 100 suppression capabilities or poses a substantial threat to safety and property.

The sensors 102 continuously monitor the environment. The processor 104 receives this data and uses the trained ML model 106-1 stored in memory 106 to classify the conditions. When the trained ML model 106-1 detects a hazardous fire based on factors such as elevated heat, dense smoke, visible flames, or harmful gas concentrations, it triggers an emergency communication sequence.

The processor 104 interfaces with the communication interface 108 to establish a connection with emergency services. The communication interface 108 may include a GPS (Global Positioning System) transceiver module configured to receive satellite signals for determining the real-time geographical location of the apparatus. The GPS module operates by triangulating signals from multiple satellites in Earth's orbit, typically requiring a minimum of four satellite signals to accurately calculate the three-dimensional position (latitude, longitude, and altitude) and the precise time. Structured message structured message containing critical details, including the apparatus's location (determined via the GPS), the type of fire hazard detected, and the status of the fire suppression system 100. For example, the message might indicate that fire-resistant panels 116-1 have been deployed and suppressants are actively being sprayed.

This real-time location information is encoded into structured communication packets and transmitted to emergency response systems or cloud-based monitoring platforms, enabling rapid localization of the hazard site and deployment of appropriate emergency services.

In one scenario, when there is a severe kitchen fire which requires external intervention, the sensors 102 may detect an intense fire, identifying high temperatures, dense smoke, and visible flames. The trained ML model 106-1 classifies the situation as a severe hazard, prompting the processor 104 to notify emergency services immediately. A message is sent detailing the exact location of kitchen and the nature of the fire, enabling firefighters to respond rapidly and effectively.

In another scenario, when there may be a need of escalation during fire suppression. Then the fire suppression system 100 may initially activates, deploying fire-resistant panels 116-1 and spraying fire suppressant 122-1. Despite this, the sensors 102 may detect that the fire continues to grow, and a gas detector identifies a potential gas leak. Recognizing the escalation, the processor 104 updates emergency services with the new information, ensuring they arrive prepared with specialized equipment for handling gas fires.

Similarly, in another scenario, when there is a communication redundancy during a fire, the fire suppression system 100 may attempt to notify emergency services but finds the primary communication interface 108 unavailable. The processor 104 may automatically switches to a backup method, such as satellite communication, ensuring the emergency notification is delivered without any delay.

Therefore, the communication interface 108 transmits the composed message to the appropriate emergency service providers. The communication interface 108 may connect to the processor 104, which manages the sequence of events leading to external communication. Preconfigured protocols stored in the memory 106 ensure reliable transmission of critical information, even in challenging conditions. By incorporating this capability, the fire suppression system 100 ensures that emergency services are promptly informed of severe or escalating hazards, enhancing the safety of users and reducing potential damage.

The trained ML model 106-1 is housed within the memory 106 and is used by the processor 104 to analyse real-time data from various sensors 102 to determine hazardous fire conditions. The trained ML model 106-1 is trained using a dataset that includes multiple examples of normal and hazardous conditions, enabling it to classify environmental conditions accurately.

The trained ML model 106-1 may utilize a series of mathematical functions, environmental variables and algorithms to analyse real-time environmental data from the sensors 102. The primary goal of this trained ML model 106-1 is to classify various conditions around the stove as safe or hazardous, enabling appropriate actions by the fire suppression system 100.

In the trained ML model 106-1, a heat detection function F₁(T) may process temperature data from the infrared camera by calculating a weighted average temperature to detect significant deviations indicating a potential fire. This function calculates a weighted average temperature T_{avg} to detect significant deviations indicating a potential fire. The heat detection function F₁(T) takes temperature data from the infrared camera as an input. The function F₁(T) may be defined by the given below relation (1).

F₁(T)=α_{T}·T_{avg} (1)

where α_{T} coefficient represents the weight or importance assigned to the temperature data T in the heat detection function F₁(T). The α_{T} helps in amplifying or reducing the influence of the temperature data on the overall classification. A higher α_{T} means that temperature data is given greater significance in determining hazardous conditions

A smoke detection function F₂(S) may measures changes in smoke concentration from the smoke detector to identify unusual patterns associated with fire. This function measures changes in smoke concentration ΔS to identify unusual smoke patterns associated with fire. The smoke detection function F₂(S) take input in the form of smoke concentration data from the smoke detector and may be defined as given below in relation (2).

F₂(S)=β_{S}·ΔS (2)

where β_{S} is the coefficient that represent the smoke weight assigned to the smoke concentration data(S) in the smoke detection function F₂(S). It adjusts the influence of smoke concentration changes on fire hazard classification. The higher Bs increases the importance of smoke data, making the model more sensitive to variations in smoke levels.

A visual analysis function F₃(I) may use a convolutional neural network (CNN) to process image data from the visible light camera, detecting visual cues such as flames or excessive smoke. This function may use a convolutional neural network (CNN) g_{CNN} to process images and detect visual cues of fire, such as flames or excessive smoke. This function F₃(I) takes image data from the visible light camera as in input and may be defined as by the given below relation (3).

F₃(I)=g_{CNN}(I) (3)

A gas leak detection function F₄(G) may analyze chemical compositions from gas detectors to detect harmful gas levels indicative of a leak. The gas leak detection function F₄(G) takes input as gas composition data from gas detectors and may be defined as given below by the relation (4).

F₄(G)=γ_{G}·φ(G_{composition}) (4)

where γ_{G} is the coefficient represents the gas composition weight assigned to the gas composition data G in the gas leak detection function F₄(G). It modulates the impact of gas composition data on identifying hazardous conditions related to gas leaks. A higher γ_{G} enhances the responsiveness to gas anomalies, ensuring quicker detection of potential gas-related hazards.

These functions (F₁(T), F₂(S), F₃(I), and F₄(G)) form the input features for the classification trained ML model 106-1, which combines them using a core classification function (C(X)). This classification function (C(X)) uses a weighted sum of input variables and biases to make predictions, applying an activation function to determine the probabilities of various classes, such as safe, cautionary, or hazardous. Mathematically, this can be represented as given below by the relation (5)

$$C ( X ) = σ ( W \cdot [ \begin{matrix}{F}_{1} ( T ) \\ {F}_{2} ( S ) \\ {F}_{3} ( I ) \\ {F}_{4} ( G )\end{matrix} ] + b ) \qquad ( 5 )$$

where X is the vector of input features combining outputs from different functions.

The training process for the classification trained ML model 106-1 involves adjusting the weights (W) and biases (b) to minimize the classification error on a labeled training dataset. This process begins with the initialization of random weights and biases. During forward propagation, the classification output (C(X)) is computed for each training example. The error between the predicted and actual labels is then measured using a loss function, such as cross-entropy loss. In the backward propagation phase, gradients of the loss with respect to weights and biases are computed, allowing for adjustments to minimize the error. This forward and backward propagation cycle is iterated for multiple epochs until the model parameters converge, ensuring an accurate and reliable classification model.

Real-time classifications by the trained ML model 106-1 determine appropriate actions by the processor 104. For instance, normal cooking activity may be classified as safe, preventing unnecessary activation of the fire suppression system 100. Overheating without fire prompts may be considered as a low-level alert, smoke without flame triggers a user alert, and localized fires result in nozzle activation for targeted suppression. The memory 106 stores the trained ML model 106-1 and relevant datasets, while the processor 104 retrieves the model and uses it to analyze data from sensors 102 in real-time. The interconnection between memory 106, processor 104, and trained ML model 106-1 ensures an intelligent, adaptive response to kitchen fire hazards by accurately classifying conditions and triggering necessary actions such as actuator control, nozzle adjustment, and user notifications.

Therefore, by combining mathematical functions to process environmental variables and continuously retraining with updated data, the classification trained ML model 106-1 provides reliability for fire suppression system 100, enhancing kitchen safety through precise and responsive technology.

In an embodiment, the actuator 112 is responsible for driving the vertical movement of the fire-resistant panels 116-1 along the guide rails 114. These fire-resistant panels 116-1 form an enclosed tunnel around the stove to contain and suppress fires.

The actuator 112 operates under the control of the processor 104. When the sensors 102 detect a hazardous fire condition, the processor 104 sends commands to the actuator 112 to deploy the fire-resistant panels 116-1. This ensures a prompt response to fire hazards, effectively containing the fire within an enclosed tunnel and allowing the array of nozzles 120 to direct fire suppressant 122-1 from the fire suppressant reservoir 122.

The actuator 112 may interact with feedback from the user device or IO device 110. This feedback-driven control ensures that the movements of the actuator 112 are dynamically adjusted based on real-time situations and user confirmation of hazardous conditions. When a hazardous fire condition is detected, the processor 104 sends a notification to the user device or IO device 110, prompting feedback. The feedback indicates the accuracy of the detected condition, confirming incidents as true hazards or false alarms. Based on this feedback, the processor 104 updates the control parameters for the actuator 112. For example, if feedback confirms that a detected fire was valid, the processor 104 ensures that the actuator 112 deploys the fire-resistant panels 116-1 more quickly next time. Conversely, if the feedback shows a false alarm, the processor 104 refines the actuator 112 control logic to reduce unnecessary deployments.

During active fire suppression, the processor 104 adjusts the movements of the actuator 112 dynamically. For instance, in scenarios where multiple user-confirmed hazards occur, the processor 104 might prioritize panel deployment in high-risk zones, ensuring efficient fire containment. The fire suppression system 100 continuously learns and adapts based on user feedback. This adaptive mechanism ensures that the operations of the actuator 112 become more precise over time, aligning better with real-world conditions and user experiences.

Consider a scenario where smoke from burnt food triggers the fire sensors 102, and the trained ML model 106-1 classifies it as a potential hazard. The processor 104 sends an alert to the user device. The user checks the kitchen and confirms it was a false alarm. This feedback is processed by the processor 104, which updates the control parameters of the actuator 112 to avoid deploying the fire-resistant panels 116-1 for similar low-risk conditions in the future.

In another scenario, if a user confirms a detected fire as valid, the processor 104 incorporates this feedback, enhancing the response time of the actuator 112 and ensuring quicker panel deployment in similar future cases. This dual feedback mechanism ensures that the actuator 112 operates with increasing accuracy and reliability, maximizing the fire suppression system's efficiency.

In an embodiment, the guide rails 114 are integral to the fire suppression system 100, providing a structured path for the vertical movement of the plurality of members 116, which include the fire-resistant panels 116-1. These guide rails 114 ensure that the fire-resistant panels 116-1 slide smoothly and precisely into place to form an enclosed tunnel around the stove. By maintaining alignment and stability, the guide rails 114 enable a swift and efficient deployment of the fire-resistant panels 116-1, essential for containing and suppressing kitchen fires effectively.

In an embodiment, the plurality of members 116 in the fire suppression system 100 includes the fire-resistant panels 116-1. These fire-resistant panels 116-1 are specifically crafted to provide robust isolation and containment of fires within the stove area. Each of the fire-resistant panels 116-1 is constructed from high-performance fire-resistant materials, ensuring that they can withstand and contain high temperatures and flames, preventing the spread of fire to other parts of the kitchen.

These materials may include intumescent coatings, fire-retardant composites, and reinforced ceramic fabrics. Intumescent coatings expand upon exposure to heat, forming an insulating layer that protects the underlying structure. Fire-retardant composites like phenolic resins or aramid fibres are lightweight yet highly resistant to high temperatures and flames. Reinforced ceramic fabrics provide exceptional thermal stability and mechanical strength, making them ideal for withstanding prolonged exposure to fire. By using these fire-resistant materials, the fire-resistant panels 116-1 effectively isolate the fire, preventing its spread and maintaining structural integrity during a fire event.

These fire-resistant panels 116-1 forms an enclosed tunnel around the stove when a hazardous fire condition is detected. The fire-resistant qualities of these fire-resistant panels 116-1 are achieved through the use of advanced materials, such as intumescent coatings, fire-retardant composites, or reinforced ceramic fabrics. These materials not only resist high temperatures but also provide structural integrity, ensuring that the panels maintain their form and function during a fire event. By incorporating these fire-resistant panels, the apparatus effectively isolates the fire, preventing it from spreading and allowing the array of nozzles 120 to target the fire with suppressants within the enclosed tunnel

In an additional embodiment, the plurality of members 116 includes a sealing mechanism 206 (shown in FIG. 3) at their base to create an airtight enclosure when the enclosed tunnel is formed around the stove. The sealing mechanism 206 enhances the effectiveness of the fire suppression system by ensuring that the enclosed tunnel is airtight, thereby limiting the availability of oxygen to the fire. The sealing mechanism 206 is integrated at the base of each fire-resistant panels 116-1. This sealing mechanism 206 may include a combination of heat-resistant gaskets, flexible seals, and interlocking edges that come together to form an airtight barrier when the fire-resistant panels 116-1 are deployed.

These heat-resistant gaskets may be place placed along the base of each fire-resistant panels 116-1, ensuring a tight seal even under high temperatures. Made from materials such as silicone or graphite, these gaskets provide a durable and heat-resistant seal that prevents air from entering the enclosed tunnel. The flexible seals may be positioned between the fire-resistant panels 116-1 and a surface on which the stove is placed, these flexible seals adjust to any unevenness, creating a uniform and airtight barrier. They are designed to withstand the thermal expansion and contraction that occurs during a fire. Alternatively, the flexible seals may be positioned between the fire-resistant panels 116-1 and the surface of the stove.

Further, each fire-resistant panels 116-1 features interlocking edges that engage when the fire-resistant panels 116-1 are deployed, ensuring that there are no gaps between adjacent fire-resistant panels 116-1. This interlocking design provides additional structural stability and reinforces the airtight nature of the enclosure.

Imagine a scenario where a pot on the stove catches fire, and the fire-resistant panels 116-1 are deployed. As the panels move into place along the guide rails 114, the heat-resistant gaskets at their base compress against the surface of the stove, forming a tight seal. The flexible seals adjust to any irregularities, ensuring a consistent barrier. Meanwhile, the interlocking edges of the fire-resistant panels 116-1 engage, securing the structure and reinforcing the airtight enclosure. This setup effectively limits the oxygen supply to the fire, containing it within the enclosed tunnel and allowing the array of nozzles 120 to suppress the fire efficiently with minimal collateral damage.

In an embodiment, the exhaust fan 118 is positioned at the upper end of the chimney the exhaust fan 118 and is responsible for removing air, smoke, and hazardous gases from the enclosed tunnel formed during the activation of the fire suppression system 100. By depleting oxygen within the tunnel, the fan directly reduces the intensity of the fire, aiding in its suppression. The operation of the exhaust fan 118 is dynamically controlled by the processor 104, which adjusts the speed of the fan based on real-time data from sensors 102. This variable-speed functionality ensures efficient air extraction tailored to the severity of the fire, optimizing safety and energy use while maintaining effective suppression.

The processor 104 leverages data from the sensors 102 to analyse the intensity of fire using key environmental inputs such as temperature levels, smoke concentration, gas composition, and visual confirmation. The processor 104 applies a trained ML model 106-1 to this data to classify the fire intensity and sends signals to the motor of the exhaust fan 118, which is equipped with a variable-speed drive. This enables precise control of the fan speed, categorized into low, moderate, and high-speed modes.

In one scenario, a large severe fire engulfs the stove due to a gas leak, producing high temperatures, dense smoke, and elevated gas concentrations. The sensors identify these conditions, and the processor determines the severity of the situation. The exhaust fan 118 operates at high speed, rapidly extracting smoke and preventing gas accumulation. This ensures a safer environment for fire suppression efforts and minimizes risks associated with hazardous gases.

In an embodiment, the array of nozzles 120 are equipped with multi-directional spray heads 120-1, strategically designed to deliver fire suppressant 122-1 to targeted zones within the enclosed tunnel. These array of nozzles 120 are connected to a fire suppressant reservoir 122, which houses various suppressant materials such as carbon dioxide, water mist, or dry chemical powder, chosen for their effectiveness against kitchen fires. The processor 104 dynamically controls the actuation of the array of nozzles 120, ensuring precise deployment of the suppressant to areas most affected by the fire. This targeted approach maximizes the efficiency of suppression efforts while conserving resources and minimizing collateral damage.

These fire suppressant 122-1 are chosen for their effectiveness in kitchen fires while minimizing damage and residue. They target specific fire types, such as grease or gas fires, by displacing oxygen, cooling flames, or disrupting chemical reactions, ensuring safety, environmental compatibility, and easy cleanup in the sensitive kitchen environment. The processor 104, operating with a trained ML model 106-1 stored in memory 106 controls the direction and flow rate of the fire suppressant 122-1 to address different fire scenarios.

These array of nozzles 120 may be divided into distinct zones within the enclosed tunnel formed by the collapsible fire-resistant panels 116-1, with each zone covering specific areas of the stove. For example, in a stove with four burners, the stove area may be divided into quadrants, Zone A (front-left burner), Zone B (front-right burner), Zone C (back-left burner), and Zone D (back-right burner). Each zone may consist of a group of arrays of nozzles 120 with independently controlled multi-directional spray heads 120-1 to ensure precision targeting based on real-time environmental data.

In one scenario of detection of an isolated fire, such as when a single pan on the stove catches fire due to overheating oil, the fire suppression system 100 detects the hazard using sensors 102. The infrared camera identifies a significant temperature increase, and the smoke detector registers elevated smoke levels in the stove area. The trained ML model 106-1 processes this data, classifying the situation as an isolated fire. In response, the processor 104 activates the array of nozzles 120 within the affected zone only, such as Zone B, and adjusts the multi-directional spray heads 120-1 to direct the suppressant over the pan. The flow rate of the fire suppressant 122-1 is calibrated to be moderate, effectively extinguishing the fire while conserving resources. This targeted approach minimizes disruption to the surrounding kitchen environment and prevents unnecessary usage of fire suppressant 122-1.

In another scenario, a more complex situation arises when a gas leak ignites, causing flames to spread across multiple burners. The gas detectors identify combustible gases, while the infrared camera and visible light camera detect widespread heat and flames. The trained ML model 106-1 integrates this data of the sensors 102 and classifies the fire as a hazardous condition with rapid escalation potential. In this scenario, the processor 104 responds by activating multiple zones of array of nozzles 120, such as Zones A, B, C, and D simultaneously. The multi-directional spray heads 120-1 in these zones adjust to cover the affected areas, deploying fire suppressant 122-1 in a coordinated manner. The flow rate is set to a high level to ensure swift containment and suppression. This zonal control prevents the fire from spreading further while maintaining efficient use of fire suppressant 122-1.

In a proactive scenario, the fire suppression system 100 detects early signs of a potential fire, such as a slight temperature increase and minimal smoke output, indicating an incipient fire from an unattended pot. The sensors 102 relay this data to the trained ML model 106-1, which classifies it as a low-risk condition. The processor 104 activates the array of nozzles 120 in the affected zone at a low flow rate, pre-emptively cooling the overheated area and preventing the fire from developing further. This early intervention ensures kitchen safety while minimizing unnecessary suppressant deployment.

The division of the array of nozzles 120 into zones enhances the precision and adaptability of the fire suppression system 100. Each zone operates independently, allowing the processor 104 to tailor the response to the specific conditions of the fire. Real-time data of sensors 102, analysed by the trained ML model 106-1, determines which zones to activate, the direction of the spray heads 120-1, and the optimal flow rate of the fire suppressant 122-1.

For instance, during a localized fire in Zone B, only the array of nozzles 120 within that zone are activated, directing fire suppressant 122-1 precisely where it is needed. In contrast, for widespread fires involving Zones B and D, the fire suppression system 100 activates both zones, ensuring comprehensive coverage. The ability to independently control each zone reduces suppressant wastage, enhances safety, and allows the fire suppression system 100 to adapt dynamically to evolving fire conditions.

In an additional embodiment, the electromagnetic valve 124 may be installed on the gas supply line 208 (shown in FIG. 2 and FIG. 3), serving as a critical safety mechanism to shut off the gas flow during hazardous fire conditions. The electromagnetic valve 124 operates under the direct control of the processor 104, which is integrated with a trained ML model 106-1. When sensors 102 detects conditions indicative of a fire or gas leak, the processor 104 promptly analyses the incoming data in real time using the trained ML model 106-1. If the data is classified as a hazardous fire condition, the processor 104 sends an immediate activation signal to the electromagnetic valve 124 to cease gas flow to the stove.

The processor 104 achieves real-time control of the electromagnetic valve 124 through a combination of continuous monitoring of the sensors 102 and rapid data processing. Data streams given by sensors 102 may include temperature spikes, elevated smoke levels, and gas concentration readings, are transmitted to the processor 104 for analysis. The trained ML model 106-1 evaluates these inputs and determines whether a fire or gas leak is present. Upon classifying the situation as hazardous, the processor 104 generates an electrical signal that actuates the electromagnetic valve 124. This signal energizes the coil within the electromagnetic valve 124, causing it to shift to the closed position, thereby stopping the gas supply line 208 to the stove and mitigating the risk of fuel feeding the fire.

This process operates with precise timing, ensuring that the electromagnetic valve 124 may be activated immediately upon detecting hazardous conditions, preventing fire escalation or further gas leakage. Additionally, the processor 104 continuously monitors environmental conditions, allowing it to reopen the electromagnetic valve 124 once it determines that the hazardous situation has been resolved, thus ensuring both safety and operational continuity. This integration of sensor-driven decision-making, ML-based classification, and real-time actuator control exemplifies the robust fire suppression and prevention capabilities.

FIG. 2 illustrates a perspective view of a fire suppression system in a non-operative mode, in accordance with an embodiment of the present disclosure. With reference to FIG. 2, there is shown a perspective view diagram 200 of the fire suppression system in the non-operative mode. The chimney 202 is installed above the stove 204 and is shown with its fire-resistant panels 116-1 retracted, leaving the stove 204 open and unobstructed for regular ventilation in the non-operative of the fire suppression system. These durable fire-resistant panels 116-1, hidden within the design of the chimney 202, are poised to spring into action when hazardous conditions arise. Guide rails 114, discreetly integrated, provide the pathway for their swift deployment.

Although not limited to this example scenario, the stove 204 is illustrated to include two burners 204-A and 204-B, and the array of nozzles 120 may be grouped into at least two different zones as zone A and zone B such that the set of nozzles in zone A are aligned and placed to target the burner 204-A and the nozzles in zone B are aligned and placed to target the burner 204-B.

In the non-operative mode, the fire suppression system 100 remains inactive while the stove 204 functions normally, ensuring uninterrupted cooking activities. The fire-resistant panels 116-1 stay retracted, keeping the chimney open for ventilation, and the array of nozzles 120 in zones A and B remains idle, with no fire suppressant 122-1 being discharged. Although the fire suppression system 100 is not actively engaged, its sensors 102, including temperature sensors, gas detectors, and smoke sensors, continuously monitor the cooking environment for any signs of danger. These sensors 102 may assess parameters such as heat levels, gas leaks, and smoke concentration, ensuring they remain within predefined safety thresholds.

The processor 104, utilizing the trained ML model 106-1, continuously analyses incoming data from the sensors 102 to determine whether a hazardous fire condition exists. If no anomaly is detected, the fire suppression system 100 remains in standby mode. The actuator 112, responsible for controlling the sliding fire-resistant panels 116-1, is not engaged, preventing any unnecessary activation of the enclosed fire suppression tunnel. Additionally, if the fire suppression system 100 features a manual override function through a user device or I/O device 110, no activation command should be received, further ensuring the fire suppression system 100 remains in a passive state.

Another component in maintaining the non-operative mode is the electromagnetic valve 124, which regulates the gas supply line 208 to the stove 204. As long as no hazardous conditions are detected, the electromagnetic valve 124 remains open, allowing normal operation of the burners (204-A and 204-B). Likewise, the fire suppressant reservoir 122 remains inactive, preventing any accidental discharge of fire suppression 122-1 agent. These combined technical conditions ensure that while the fire suppression system 100 continuously monitors for fire hazards, it does not interfere with normal kitchen operations, only activating when necessary to protect against fire-related risks.

FIG. 3 illustrates a perspective view of a fire suppression system in an operative mode, in accordance with an embodiment of the present disclosure. With reference to the FIG. 3 there is shown a perspective view diagram 300 of the fire suppression system in the operative mode. The chimney 202 is installed above the stove 204 which may include two burners 204-A and 204-B. The array of nozzles 120 is divided into two zones: Zone A, targeting burner 204-A, and Zone B, targeting the burner 204-B. The fire-resistant panels 116-1 are meticulously deployed to form an enclosed tunnel covering the stove 204 from all four sides. This tunnel, crafted with precision and reliability, creates a protective barrier around the potential fire source, preventing the spread of flames and enabling targeted fire suppression. In the example illustrated in FIG. 3, there is shown a fire-resistant panel 116-1 along each of the four sides of the stove 204, so that when collapsed down, these four fire-resistant panels may form a tunnel that encloses the stove 204. Although in FIG. 3, for clarity purpose only, a fire-resistant panel is not shown in the front side or user facing side of the stove 204. A person skilled in the art will appreciate that while it is not possible to illustrate a fire-resistant panel in the deployed state on the front side in the front perspective view of the stove 204 due to clarity requirements, it is possible in practice to implement the fire-resistant panels from all sides of the stove 204.

In the event of a fire hazard, the fire suppression system 100 swiftly transitions into its operative mode, ensuring immediate response to the detected danger. As illustrated in FIG. 3, the sensors 102 detect a hazardous condition, such as an uncontrollable flame, excessive heat, or gas leakage, triggering the processor 104 to analyse the data using the trained ML model 106-1. Upon confirming a fire threat or hazard, the actuator 112 engages, causing the fire-resistant panels 116-1 to slide into place, forming an enclosed tunnel around the stove 204. Simultaneously, the electromagnetic valve 124 shuts off the gas supply line 208 to prevent further fuel from feeding the fire. The array of nozzles 120 activates based on the location of the fire, with zone A targeting burner 204-A and zone B targeting burner 204-B, discharging an appropriate fire suppressant 122-1 to swiftly extinguish the flames. The fire suppression system 100 continues monitoring the environment, ensuring that the fire is fully suppressed before gradually returning to its non-operative mode, allowing normal kitchen activities to resume.

In some instances, the fire suppression system 100 may detect conditions that resemble a fire hazard, such as intense cooking flames, steam, or high heat generated during normal usage. To ensure accuracy and prevent unnecessary activation, the sensors 102 relay data to the processor 104, which analyses the inputs using the trained ML model 106-1. Before initiating the fire suppression sequence, the fire suppression system 100 sends a notification to the user via the communication interface 108 or I/O device 110, requesting confirmation of the detected condition. If the user confirms that no fire emergency exists, the processor 104 overrides the activation, ensuring that the fire-resistant panels 116-1 remain retracted and the fire suppressant 122-1 is not discharged. This feedback is then logged and used to further enhance the ML model 106-1, refining its ability to differentiate between hazardous and non-hazardous conditions. In cases where the panels have already begun moving, the actuator 112 can retract them, seamlessly returning the system to its non-operative mode. This intelligent validation process enhances fire suppression system 100 reliability, ensuring safety without unnecessary intervention.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steppers may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A fire suppression system to extinguish kitchen fire, comprising:
a chimney installed above a stove, the chimney including a guide rail, and a plurality of members configured to slide vertically along the guide rail, wherein at least one member of the plurality of members is installed along each side of the chimney;
a set of sensors configured to detect environmental conditions in proximity to the stove;
an actuator coupled to the plurality of members of the chimney;
an array of nozzles integrated with the chimney, wherein the array of nozzles is connected a high-pressure fire suppressant reservoir;
an exhaust fan connected to an end of the chimney;
a processor configured to:
receive, from the sensors, information related to the environmental conditions detected in proximity to the stove;
apply a trained machine learning (ML) model on the received information to determine the detected environmental conditions as a hazardous fire condition in proximity to the stove;
upon the determination of the hazardous fire condition in proximity to the stove,
control the actuator to slide the plurality of members downward to form an enclosed tunnel around the stove,
activate the exhaust fan to extract air from the enclosed tunnel formed around the stove, and
activate the array of nozzles to spray fire suppressant within the enclosed tunnel from the high-pressure fire suppressant reservoir.

2. The system of claim 1, wherein the plurality of members comprises fire-resistant panels.

3. The system of claim 1, wherein the plurality of members includes a sealing mechanism at their base to create an airtight enclosure when the enclosed tunnel is formed around the stove.

4. The system of claim 1, wherein the set of sensors comprises:
an infrared camera configured to detect the presence and intensity of heat near the stove;
a smoke detector configured to measure smoke concentration in proximity to the stove;
a visible light camera configured to capture real-time images of the stove for image processing; and
gas detectors configured to detect gas leaks by analysing chemical compositions in the environment in the proximity to the stove.

5. The system of claim 4, wherein the information related to the environmental conditions detected in proximity to the stove comprises information detected by the infrared camera, the smoke detector, the visible light camera, and the gas detectors.

6. The system of claim 1, wherein the fire suppressant may include one of carbon dioxide, carbon monoxide, dry chemical powder, water mist, or inert gas.

7. The system of claim 1, wherein
the array of nozzles includes multi-directional spray heads, and
the processor is further configured to control the array of nozzles to adjust a direction and flow rate of the fire suppressant based on the information related to the environmental conditions detected in proximity to the stove.

8. The system of claim 1, wherein the array of nozzles is divided into zones, each zone being independently controllable to target specific areas of the enclosed tunnel formed around the stove.

9. The system of claim 1, wherein the processor is further configured to control the exhaust fan to operate at variable speeds depending on an intensity of the hazardous fire condition.

10. The system of claim 1, wherein the processor is further configured to send a notification to a user device prompting confirmation of the determined hazardous fire condition.

11. The system of claim 10, wherein the processor is further configured to:
receive, from the user device, feedback to the prompt confirming validity of the determination made by the ML model regarding the hazardous fire condition; and
retrain the ML model based on the feedback received from the user device.

12. The system of claim 11, wherein the processor is further configured to control the actuator based on the feedback received from the user device.

13. The system of claim 1, further comprising an electro-mechanical valve installed on a gas supply line supplying gas to the stove, wherein the processor is further configured to control the electro-mechanical valve to cease gas flow to the stove upon detection of the hazardous fire condition.

14. The system of claim 1, wherein the processor is configured to communicate with emergency services when the hazardous fire condition is determined.
